(19) United States
(12) Patent Application Publication
(10) Pub. No.: US 2023/0061238 A1
(43) Pub. Date: Mar. 2, 2023

(54) A CAMERA SYSTEM AND A METHOD FOR DETERMINING A WEATHER SITUATION

(71) Applicant: Sony Group Corporation, Tokyo (JP)

(72) Inventor: Matthias FREY, Stuttgart (DE)

(73) Assignee: Sony Group Corporation, Tokyo (JP)

(21) Appl. No.: 17/799,926

(22) PCT Filed: Feb. 18, 2021
(86) PCT No.: PCT/EP2021/054062

§ 371 Date: Aug. 16, 2022

(30) Foreign Application Priority Data
Feb. 26, 2020 (EP) 20159618.6

(51) Int. Cl. G06V 20/17; G06V 40/10; G01W 1/02; B64D 47/08; B64C 39/02

(52) U.S. Cl. CPC G06V 20/17; G06V 40/10; G01W 1/02; B64D 47/08; B64C 39/024; B64C 2201/127

(57) ABSTRACT

The present disclosure relates to a camera system for an aerial vehicle. The camera system comprises at least one camera mounted to the aerial vehicle and configured to provide image data of an environment of the aerial vehicle. Further, the camera system comprises a data processing circuitry configured to derive a weather situation in the environment by applying computer vision to the image data.

### FIELD

Embodiments of the present disclosure relate to a method for determining a weather situation and a camera system applicable for this purpose, in particular for an aerial vehicle.

### BACKGROUND

Weather observations play an important role especially in fields of science, but also in commercial or private sectors.

In some situations, a person who is inside a building may want to know a current weather situation outside without going outside, for example, in order to dress appropriately.

Established concepts for weather observations may require several different sensors, such as humidity sensors, temperature sensors, wind sensors and the like for observations of the weather situation.

Document US 2019/0130195 A1 describes an information providing system which comprises an acquiring unit for providing an image of a person and an analyzing unit. The analyzing unit is configured to analyze the image in order to generate at least situation information indicating whether the person carries a rain gear.

This concept for weather observations uses a plurality of ground-based cameras to observe a current weather situation at multiple locations of an area to be observed. Therefore, applications of this concept are limited to ground-based implementations within a predefined area.

Hence, there is a demand for an improved concept for weather observations and particularly for weather observations at multiple locations.

This demand can be satisfied by the subject-matter of the appended independent and dependent claims.

### SUMMARY

According to a first aspect, the present disclosure relates to a camera system for an aerial vehicle. The camera system comprises at least one camera mounted to the aerial vehicle and configured to provide image data of an environment of around the aerial vehicle. Further, the camera system comprises a data processing circuitry configured to derive a weather situation in the environment by applying computer vision to the image data.

The camera can be a photo camera or a movie camera. Accordingly, the image data can comprise one or more images and/or videos of the environment.

The camera and the aerial vehicle can be preferably used in an outdoor environment.

An orientation of the camera can vary to monitor the environment sideways, below or above the aerial vehicle. The camera, for example, can point upwards to monitor a sky above the aerial vehicle, or sideways for monitoring buildings or landmarks, or downwards to monitor people below the aerial vehicle.

Depending on the weather situation, the monitored environment (e.g. the monitored sky, landmark or people) may appear differently and thus, the image data can reflect the weather situation.

By definition, computer vision includes techniques and methods for acquiring, processing, analyzing and understanding digital images, and extraction of high-dimensional data from the real world in order to produce numerical or symbolic information.

In context of the present disclosure, computer vision can be used to detect weather-specific features and/or objects of the environment in order to derive the (current) weather situation, as stated in more detail later.

The aerial vehicle can move to different locations to observe the weather situations there and, for example, to generate a map reflecting the weather situations at the different locations. Preferably, the aerial vehicle is an unmanned aerial vehicle (UAV), as an operation of UAVs can be less expensive and automatized, as opposed to other aerial vehicles. Alternatively, the aerial vehicle can be another aircraft, such as a helicopter, a plane or the like.

According to a second aspect, the present disclosure relates to an aerial vehicle which comprises the aforementioned camera system for deriving a weather situation in an environment of the aerial vehicle.

According to a third aspect, the present disclosure relates to a method for observing a weather situation. The method comprises providing image data of an environment using a camera attached to an aerial vehicle. Further, the method provides for deriving a weather situation within the environment by applying computer vision to the image data.

According to a fourth aspect, the present disclosure relates a computer program comprising instructions, which, when the computer program is executed by a processor cause the processor to carry out the aforementioned method.

It should be noted that features mentioned herein in connection with the aforementioned camera system may be also applied analogously to the above method, aerial vehicle and the computer program and vice versa.

### BRIEF DESCRIPTION OF THE FIGURES

Some examples of apparatuses and/or methods will be described in the following by way of example only, and with reference to the accompanying figures, in which

FIG. 1 illustrates a camera system for weather observations using an aerial vehicle;

FIG. 2a illustrates three scenarios of sky observations;

FIG. 2b illustrates three scenarios of landmark observations;

FIG. 2c illustrates three scenarios of “people observation”; and

FIG. 3 shows a flow chart schematically illustrating a method for weather observation.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Same or like numbers refer to like or similar elements throughout the description of the figures, which may be implemented iden-tically or in modified form when compared to one another while providing for the same or a similar functionality.

It will be understood that when an element is referred to as being “connected” or “coupled” to another element, the elements may be directly connected or coupled via one or more in-tervening elements. If two elements A and B are combined using an “or”, this is to be understood to disclose all possible combinations, i.e. only A, only B as well as A and B, if not explicitly or implicitly defined otherwise. An alternative wording for the same combinations is “at least one of A and B” or “A and/or B”. The same applies, mutatis mutandis, for combinations of more than two Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

Established concepts for weather observation on the one hand require multiple sensors and on the other hand may be limited to ground-based implementations.

Hence, there is a demand for an improved concept for weather observations and particularly for weather observations at multiple locations.

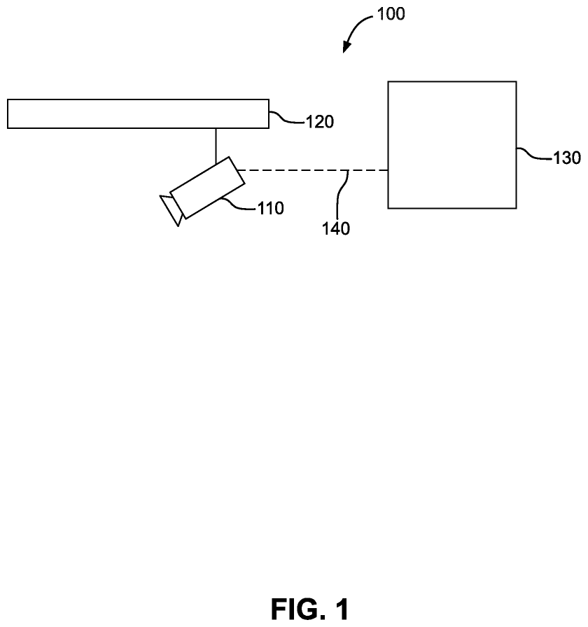

FIG. 1 illustrates a camera system 100 for an aerial vehicle 120. The camera system 100 comprises a camera 110 which is mounted to the aerial vehicle 120 and configured to provide image data of an environment of the aerial vehicle 120. Further, the camera system 100 comprises a data processing circuitry 130 which is configured to derive a weather situation in the environment by applying computer vision to the image data.

The aerial vehicle 120, for example, is an unmanned aerial vehicle (UAV).

The camera 110, for example, is rigidly mounted to the UAV 120. Alternatively, the camera 110 can be mounted movably and optionally, pivoted for adaptive adjustments of its pose. Optionally, the pose can be controlled from remote. To this end, a pivoted mounting of the camera 110 can be coupled to a control unit (not shown) via a wireless connection.

As can be seen in FIG. 1, the data processing circuitry 130 is installed remote from the UAV 120 for saving weight of the UAV 120. Consequently, the data processing circuitry 130, for example, is not limited by a maximal payload of the UAV 120 and thus may be less expensive than light-weight on-board implementations of the data processing circuitry 130 which are mounted to the UAV 120.

In contrast to the embodiment of FIG. 1, the data processing circuitry 130 can be attached to the UAV 120 or the aerial vehicle in some further embodiments.

In order to communicate the image data to the data processing circuitry 130, the camera system 100 further comprises a wireless interface 140 between the camera 120 and the data processing circuitry.

A skilled person having benefit from the present disclosure will appreciate that the wireless interface 140 can be understood as telecommunication equipment for transmission of the image data by radio, optical or other electromagnetic systems.

This, for example, allows the UAV 120 to move without any limitations by the communica-tion of the image data.

The camera 110 can be a (customary) photographic camera or a movie camera to either provide a single camera image or a video as image data of the environment.

In some further embodiments, the camera system 100 comprises multiple, and optionally, diverse cameras to increase a spatial resolution of the image data and/or an availability of the camera system 100.

The data processing circuitry 130 can include a machine-learning based computing system like an artificial neural network (ANN). This, for example, is configured to check the image data for characteristics, which are indicative of weather situations, using computer vision. To this end, the ANN may be initially “trained” with training data using supervised, unsu-pervised or reinforcement learning.

Computer vision can comprise object recognition and identification.

In practice, the training data can comprise pairs of example images and a corresponding output (e.g. a predefined weather situation), which is commonly denoted as a target (or label). For example, a current model of the ANN is run with the training data and produces a result, which is then compared with the target, for each example image of the training data to fit parameters (e.g. weights of connections between neurons in the ANN).

As a result, the data processing circuitry 130 can automatically infer on the weather from the image data using the ANN.

Alternatively or additionally the data processing circuitry 130 can use so-called “thresholding” and “edge detection” algorithms and/or heuristic object detection to infer on the weather from the image data. Heuristic object detection, for example, requires less computation power and can be less expensive than the ANN. Apart from that, inferences on the weather using the ANN can be more reliable than inferences through heuristic object detection.

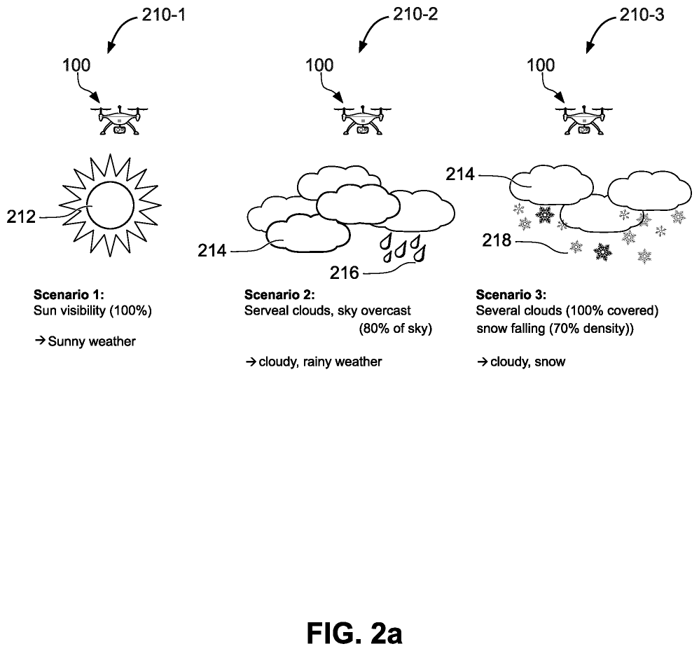

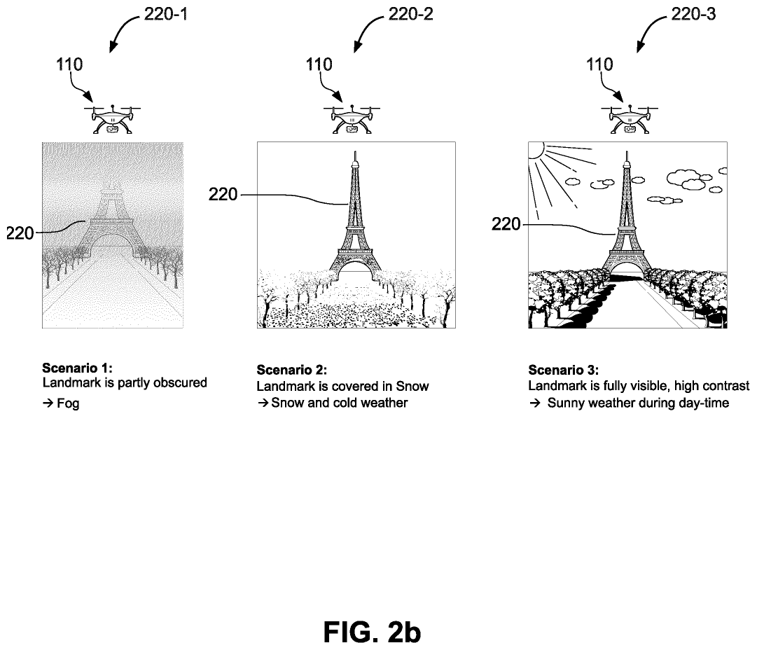

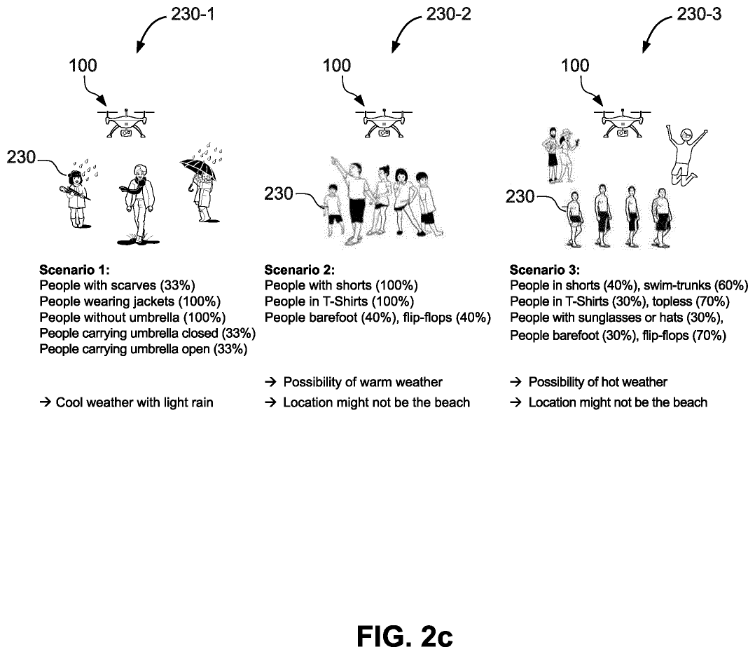

FIG. 2a, FIG. 2b and FIG. 2c illustrates three different ways to infer on the weather situation from the image data.

FIG. 2a illustrates a concept for weather observations using image data of the sky. Hence, this concept can also be referred to as “sky observation”.

For this, the camera 110 can be configured to provide at least a (first) portion of the image data which is indicative of an appearance of the sky within the environment. Further, the data processing circuitry 130 can be configured to derive the weather situation from the appearance of the sky by applying computer vision to the (first) above portion of the image data of the sky.

In context of the present disclosure, the sky can be understood as the Earth's atmosphere or at least some of its atmospheric layers whose appearance particularly depends on a visibility of the sun 212 and on weather phenomena such as fog, hail, snow 218, rain 216 and/or clouds 214.

Those weather phenomena especially occur within the troposphere and may be indicative of the current weather situation in the observed environment. Hence, the weather situation can be inferred from the weather phenomena or the sun's visibility using computer vision.

The UAV 120 can move within the troposphere and the camera 110 can be facing up or sideways to record the aforementioned weather phenomena and/or the sun. In some further cases, the UAV 120 can fly above the troposphere to monitor the weather phenomena from above.

With the ANN, the data processing circuitry 130 can check the image data for an appearance and/or the visibility of the sun and/or the weather phenomena and infer on the weather situation.

To be more specific, the concept of sky observation should be described by reference to three scenarios 210-1, 210-2 and 210-3 of sky observation in the following.

In a first scenario 210-1, the weather is sunny, in a second scenario 210-2, the weather is rainy and cloudy and in a third scenario 220-3, it is snowing.

In the first scenario 210-1, the image data are characteristic of a maximal visibility of the sun. For example, a brightness of the image data can be indicative of the visibility of the sun.

Consequently, in the first scenario, the ANN of the data processing circuitry 130 can de-scribe the weather situation as being “sunny” and/or “not rainy/foggy” based on the brightness of the image data. Optionally, the ANN can come to this conclusion if it does not detect any of the aforementioned weather phenomena using computer vision (e.g. object recognition).

In a second and a third scenario 210-2 and 210-3 the camera system 100 can analogously infer on rain 216, an overcast sky 214 or on snowfall 218, respectively, from the respective image data. For this, the ANN may use computer vision to detect rain drops, clouds and snow, respectively.

As can be seen in FIG. 2a, the ANN may also determine an amount of clouds or a density of the snow for a more detailed estimation of the weather situation.

FIG. 2b illustrates a concept for weather observations using image data of a landmark 220 placed within the environment. Hence, this concept can also be referred to as “landmark observation”.

For the landmark observation, the camera 110 can be configured to provide at least a (second) portion of the image data which is indicative of an appearance of the landmark 220 within the environment. Further, the data processing circuitry 130 can derive the weather situation from the appearance of the landmark 200 by applying computer vision to the (second) above portion of the image data of the landmark.

In FIG. 2b, the landmark corresponds to a tower. In further applications, the landmark can be a building or part of a landscape.

In a first scenario 220-1 of the landmark observation, the weather is foggy, in a second scenario 220-2, the environment and is at least partly covered with snow and in a third scenario 220-3, the weather is sunny.

In the first scenario 220-1 of the landmark observation, the tower's 220 appearance is influ-enced by fog. In particular, the tower 220 is partially obscured due to fog.

Consequently, the ANN can infer on a foggy weather situation due to partial occlusion of the tower 220 which may be reflected in the image data.

In the second scenario 220-2, the tower 220 can be fully visible but a contrast of the tower 220 can be lower than in a third scenario 220-3 due to a diffuse illumination of the tower 220. Hence, the ANN can distinguish between sunny and cloudy weather. Further, the ANN may determine a contrast between the tower 220 and its surrounding. In this way, the ANN may further be able to determine whether the environment is covered with snow.

Analogously, the camera system 100 can determine whether it is raining depending on whether the tower 220 appears wet.

FIG. 2c illustrates a concept for weather observations using image data of people 230 within the environment. Hence, this concept can also be referred to as “people observation”.

For this, the camera 110 can be configured to provide at least a (third) portion of the image data which is indicative of a gear of people 230 within the environment. Further, the data processing circuitry 130 is configured to derive the weather situation from the clothes of the people 230 by applying computer vision to the (third) above portion of the image data of people.

In a first scenario 230-1 of the people 230 observation, the people carry rain gear, scarves and umbrellas because the weather is cold and/or rainy. In a second scenario 230-2 the people 230 wear shorts, t-shirts and no shoes or flip-flops due to a sunny and warm weather situation. In a third scenario 230-3, the people 230 only wear shorts but no shirts or t-shirts.

As a result of the people observation, in the first scenario 230-1 of the people observation the ANN, for example, infers on rainy and/or cold weather in response to a detection of the rain gear and the scarves. Optionally, the ANN can distinguish between open and closed umbrellas to observe if it is currently raining.

In the second scenario 230-2, the ANN can detect the shorts, the t-shirts and the flip-flops which are indicative of a warm weather situation. Consequently, the ANN can denote the current weather situation as being sunny and/or warm. The ANN, optionally, can determine whether the environment is at a lake, a sea or a beach depending on if the people wear swimwear.

In this way, the ANN can specify that the location of the third scenario 230-2 may be at a beach.

The people observation using the ANN, for example, also allows a more detailed estimation of the weather situation and/or the temperature depending on an amount of people carrying rain gear, scarves, sunglasses, flip-flops, shorts and/or being topless or barefoot. Further, the camera system 100, for example, determines a number of open and/or closed umbrellas to estimate an intensity of a rainfall.

Results of the sky observation, the landmark observation and/or the people observation may be indicative of a probability of a presence of each of one or more possible weather situations. Those probabilities can be derived by applying computer vision to the image data. As a result, the data processing circuitry 130 can derive the weather situation from the probabilities of the possible weather situations.

The probability of a weather situation, for example, depends on the amount of clouds, the density of the snow or the sun's visibility detected by the ANN in connection with sky observation.

For people observation, the probability of a weather situation, for example, depends on the amount of people 230 carrying rain gear (e.g. umbrellas), scarves, sunglasses, flip-flops or shorts and/or being topless or barefoot. The probability may be also indicative of an amount of open and/or closed umbrellas detected by the ANN.

For landmark observation, the probability may particularly depend on a degree of the detected contrast or the detected occlusion of the landmark 220.

In some embodiments, the camera system 100 can combine the sky observation, the landmark observation and the people observation for determining the weather situation at one location.

For this, the camera system 100 may either comprise at least one camera for each of the sky observation, the landmark observation and the people observation, or a single camera which can be used for the sky observation, the landmark observation and the people observation. Such a single camera, for example, may be “movably” mounted such that the camera can change its pose to either observe the sky, the landmark 220 or the people 230.

The data processing circuitry 130 can apply computer vision on each of the portions of image data related to the sky observation, the landmark observation and the people observation, respectively to make multiple conclusions on the weather situation each based on the sky observation, the landmark observation or the people observation.

Thus, the data processing circuitry 130 can obtain a probability of a presence of a weather situation for each of the sky observation, the landmark observation and the people observation to obtain a combined result from the probabilities.

For example, the camera system 100 can obtain a probability for a rainy weather situation and a “non-rainy” weather situation for each of the sky observation, the landmark observation and the people observation and can combine the probabilities according to:

P(rain)=P(rain|sky observation)*P(rain|landmark observation)*P(rain|people obser-vation)/(P(rain| sky observation)*P(rain|landmark observation)*P(rain|people obser-vation)+P(no rain|sky observation)*P(no rain|landmark observation)*P(no rain|people observation)), wherein P(rain|sky observation) and P(no rain|sky observation) denotes the probability of a rainy or a non-rainy weather situation observed through sky observation, P(rain|landmark observation) and P(no rain|landmark observation) denotes the probability of a rainy or a non-rainy weather situation observed through landmark observation and wherein P(rain 1 people observation) and P(no rain|people observation) denotes the probability of a rainy or a non-rainy weather situation observed through people observation.

In some further embodiments, the camera system 100 further comprises a localization system (not shown) to provide a position of the UAV 120 and to associate the position of the UAV 120 with the derived weather situation.

This, for example, allows to record the weather situation in a digital map. In some applications, the camera system 100 can observe the weather situation at multiple locations to generate a weather map in this way.

The localization system can comprise a GPS receiver or a gyroscope to obtain the position of the UAV 120.

In some embodiments, the camera system 100 further comprises a thermometer configured to measure a temperature of the environment. The data processing circuitry 130 derive the weather situation in the environment using the temperature.

For example, the data processing circuitry 130 uses the temperature for a verification or completion of a result of the weather observation using the camera 110. Through sky obser-vation, for example, the data processing circuitry 130 may only be able to derive whether it is sunny or not without determining the temperature. In such cases, the camera system 100 can complement the result of the sky observation with the temperature measured by the thermometer.

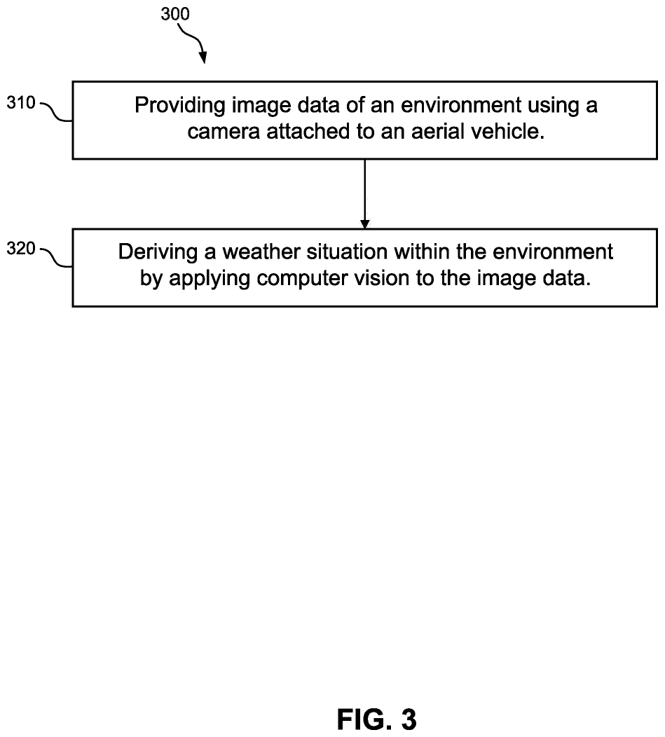

FIG. 3 shows a flow chart schematically illustrating a method 300 for weather observation.

The method 300 comprises providing 310 image data of an environment using a camera attached to an aerial vehicle and deriving 320 a weather situation within the environment by applying computer vision to the image data.

The following examples pertain to further embodiments:

(1) A camera system for an aerial vehicle, comprising:
at least one camera mounted to the aerial vehicle and configured to provide image data of an environment of the aerial vehicle; and
a data processing circuitry configured to derive a weather situation in the environment by applying computer vision to the image data.

(2) Camera system of (1),
wherein the data processing circuitry is installed remote from the aerial vehicle; and
wherein the camera system further comprises a wireless interface between the camera and the data processing circuitry to communicate the image data to the data processing circuitry.

(3) Camera system of any one of (1) or (2),
the camera is configured to provide a first portion of the image data which is indicative of an appearance of the sky within the environment; and
wherein the data processing circuitry is configured to derive the weather situation from the appearance of a sky by applying computer vision to the first portion of the image data.

(4) Camera system of any one of (1) to (3),
the camera is configured to provide a second portion of the image data which is indicative of an appearance of a landmark within the environment; and
wherein the data processing circuitry is configured to derive the weather situation from the appearance of the landmark by applying computer vision to the second portion of the image data.

(5) Camera system of any one of (1) to (4), wherein the image data includes at least one of fog, snow, rain and a cloud.

(6) Camera system of any one of (1) to (5),
wherein the camera is configured to provide a third portion of the image data which is indicative of a gear of people within the environment; and
wherein the data processing circuitry is configured to derive the weather situation from the clothes of the people by applying computer vision to the third portion of the image data.

(7) Camera system of any one of (1) to (6), wherein the data processing circuitry is configured to
derive a probability of a presence of each of one or more possible weather situations by applying computer vision to the image data; and
derive the weather situation from the probabilities of the possible weather situations.

(8) Camera system of (3), (4) and (6), wherein the data processing circuitry is configured to derive a first, a second and a third probability of a presence of each of one or more possible weather situations by applying computer vision to the respective first portion, second portion and third portion of the image data; and
derive the weather situation from a combination of the first, the second and the third probabilities.

(9) Camera system of any one of (1) to (8),
wherein the camera system further comprises a localization system configured to provide a position of the aerial vehicle; and
wherein the data processing circuitry is configured to associate the position of the aerial vehicle with the derived weather situation.

(10) Camera system of (9), wherein the data processing circuitry is further configured to:
obtain a digital map of the environment; and
record the derived weather situation in the digital map according to the position of the aerial vehicle.

(11) Camera system of any one of (1) to (10),
further comprising a thermometer configured to measure a temperature of the environment;
wherein the data processing circuitry is configured to derive the weather situation in the environment using the temperature.

(12) An aerial vehicle, comprising the camera system of any one of (1) to (11) for deriving a weather situation in an environment of the aerial vehicle.

(13) A method for observing a weather situation, comprising:
providing image data of an environment using a camera attached to an aerial vehicle; and
deriving a weather situation within the environment by applying computer vision to the image data.

(14) A computer program comprising instructions, which, when the computer program is executed by a processor cause the processor to carry out the method of (13).

The aspects and features mentioned and described together with one or more of the previ-ously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for illustrative pur-poses to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a signal”, “means for generating a signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A camera system for an aerial vehicle, comprising:
at least one camera mounted to the aerial vehicle and configured to provide image data of an environment of the aerial vehicle; and
a data processing circuitry configured to derive a weather situation in the environment by applying computer vision to the image data.

2. Camera system of claim 1,
wherein the data processing circuitry is installed remote from the aerial vehicle; and
wherein the camera system further comprises a wireless interface between the camera and the data processing circuitry to communicate the image data to the data processing circuitry.

3. Camera system of claim 1,
the camera is configured to provide a first portion of the image data which is indicative of an appearance of the sky within the environment; and
wherein the data processing circuitry is configured to derive the weather situation from the appearance of a sky by applying computer vision to the first portion of the image data.

4. Camera system of claim 1,
the camera is configured to provide a second portion of the image data which is indicative of an appearance of a landmark within the environment; and
wherein the data processing circuitry is configured to derive the weather situation from the appearance of the landmark by applying computer vision to the second portion of the image data.

5. Camera system of claim 1, wherein the image data includes at least one of fog, snow, rain and a cloud.

6. Camera system of claim 1,
wherein the camera is configured to provide a third portion of the image data which is indicative of a gear of people within the environment; and
wherein the data processing circuitry is configured to derive the weather situation from the clothes of the people by applying computer vision to the third portion of the image data.

7. Camera system of claim 1, wherein the data processing circuitry is configured to
derive a probability of a presence of each of one or more possible weather situations by applying computer vision to the image data; and
derive the weather situation from the probabilities of the possible weather situations.

8. Camera system of claims 3, 4 and 6, wherein the data processing circuitry is configured to
derive a first, a second and a third probability of a presence of each of one or more possible weather situations by applying computer vision to the respective first portion, second portion and third portion of the image data; and
derive the weather situation from a combination of the first, the second and the third probabilities.

9. Camera system of claim 1,
wherein the camera system further comprises a localization system configured to provide a position of the aerial vehicle; and
wherein the data processing circuitry is configured to associate the position of the aerial vehicle with the derived weather situation.

10. Camera system of claim 9, wherein the data processing circuitry is further configured to:
obtain a digital map of the environment; and
record the derived weather situation in the digital map according to the position of the aerial vehicle.

11. Camera system of claim 1,
further comprising a thermometer configured to measure a temperature of the environment;
wherein the data processing circuitry is configured to derive the weather situation in the environment using the temperature.

12. An aerial vehicle, comprising the camera system of claim 1 for deriving a weather situation in an environment of the aerial vehicle.

13. A method for observing a weather situation, comprising:
providing image data of an environment using a camera attached to an aerial vehicle; and
deriving a weather situation within the environment by applying computer vision to the image data.

14. A computer program comprising instructions, which, when the computer program is executed by a processor cause the processor to carry out the method of claim 13.
